(19) United States
(12) Patent Application Publication
(10) Pub. No.: US 2010/0101526 A1
(43) Pub. Date: Apr. 29, 2010

(54) Method Of Preparing A Surface For Applying A Spray Coating

(75) Inventors: Michael Schaefer, St. Clair Shores, MI (US); Robert Vandermolen, Brighton, MI (US); Deny Tanis, Howell, MI (US); Gerhard Flores, Ostfildern (DE)

Correspondence Address: Brinks Hofer Gilson & Lione/Ann Arbor, 524 South Main Street, Suite 200, Ann Arbor, MI, 48104, US

(73) Assignee: Gehring Gmbh & Co. KG, Ostildern (DE)

(21) Appl. No.: 12/257,070

(22) Filed: Oct. 23, 2008

(51) Int. Cl. F02F 1/00; B05D 3/12; B05C 11/00

(52) U.S. Cl. 123/193.2; 427/444; 427/554; 118/72

(57) ABSTRACT

A method of preparing the surface of a substrate (3) for applying a thermal spray coating (2), wherein recesses are introduced in the surface to be coated, which are subsequently shaped such that the created structures have undercuts. A web (4) having a flat plateau surface (4-1) is created by machining, which, starting at the center (5) of the plateau surface (4-1), is shaped into a widened region (6) such that roof-shaped projections (6′, 6″) directed opposite one another on both sides are created, which form undercuts (10) with the sides thereof facing the surface (3-1) of the substrate (3).

### FIELD

The invention relates to a method of preparing the surface of a substrate for applying a thermal spray coating, wherein recesses having undercuts are introduced in the surface to be coated by machining, serving the bonding of the spray coating. To this end, a substrate preferably is the piston running surface of an internal combustion engine, which is configured as a cylinder bore of a crankcase or as a cylinder liner. The invention further relates to a tool that is suitable for this purpose and to a component machined according to the method.

Thermal spray coating is increasingly being used in internal combustion engines. Aluminum alloys are currently used for crankcases or engine blocks in order to save weight, but the surfaces thereof are not suitable for the tribological stress caused by the pistons moving inside the cylinder bores. Nevertheless, in order to benefit from the advantages of lightweight designs, thermal coatings are applied onto the internal surfaces of the cylinder bores, which have the desired tribological properties with regard to friction and wear after finishing. In order to create a firm connection between the thermal spray coating and, for example, the surface of a cylinder bore, it is necessary to pre-treat the substrate by creating a roughened profile onto which the coating adequately adheres.

### BACKGROUND

A method of the above-mentioned type is known from DE 10 2006 045 275 B3 (=WO 2008/034419 A1). With this method, the undercuts are created by means of a complicated movement of at least two cutting plates. The disadvantage not only is the complicated production kinematics, but also the short service life of the cutting plates because of their filigree configuration. Therefore, this method is not appropriate for serial production.

A method is known from DE 10 2006 004 769 A1 (=WO 2007/087989 A1), wherein in a first process step, which may be also be a machining operation, recesses or grooves are introduced in the surface of a substrate having a mushroom-shaped or push button-shaped structure. Subsequently, undercuts are created by means of machining or high-pressure water jets, bending or buckling the raised structures. This process is complex and provides only very imprecisely roughened profiles, which strongly depend on the material used and therefore does not ensure consistent results.

A method is known from DE 101 39 516 A1, in which bound cutting crystals are used as cutting materials for the pretreatment. Undercuts for a positive fit with the adhering coating are not created. Therefore, the adhesive pull strength is only limited. Furthermore, from DE 102 56 460 A1 (=US 2003/0152699 A 1) the creation of a roughened profile by means of fine boring is known. Methods and tools for laser beam machining are also known from the article by T. Abeln, G. Flores and U. Klink, Laserstrukturierung—Verbesserung der tribologischen Eigenschaften von Oberflächen (Laser structuring—Improving the tribological properties of surfaces), VDI-Z. 7/8, 2002, as well as from DE 20 2005 011 772 UI and EP 1 464 436 A1.

A roughened profile having undercuts for the application of heat insulation and heat dissipation layers onto components, which are used in fusion reactors where highly concentrated magnetic field plasma is generated, is known from U.S. Pat. No. 7,220,458 B2. The roughened profile is created by sawing, milling, etching or roughening by means of a laser or electric arc. Apart from heat dissipation, the applied coating serves the provision of soft paths for mechanical stress reduction.

### SUMMARY

According to the present invention, this object is attained in that a web having a raised plateau surface is created by machining, which is subsequently transformed into a widened region, starting at approximately the center of the plateau surface, said widened region forming roof-shaped projections to both sides, which form undercuts facing the substrate.

Thus, the object is attained, in short, by the combination of producing a preliminary machined profile, preferably using a machining or beam tool, and subsequent shaping, for example by roller burnishing or pressing, by means of which the roughened profile is created.

This method is advantageous in that—with the configuration of a corresponding tool—the production of the roughened profile may be associated with the kinematics of a fine boring spindle. The creation of a roughened profile thus may be integrated in the cycle time of a production line for manufacturing an engine block. To this end, relatively low roughness levels of clearly less than 100 μm may be created, so that the roughened profile only has to be filled in with a small amount of coating agent.

By means of the undercuts configured in this way, a reliable positive fit is obtained between the substrate and the sprayed coating during the subsequent thermal spray coating with melted metal particles. High adhesive pull strength is further achieved in that contraction strains and adhesion of the thermally applied coating are significantly increased by this procedure.

The advantage of the tool and method further is the considerably longer service life of the tools than has been possible with the currently used mechanical roughening processes. Adhesive pull strengths as high as ≧40 MPa are possible.

### DRAWINGS

Exemplary embodiments of the invention and their advantageous refinements are explained in more detail below with reference to the attached drawings. The drawings show:

FIG. 1 a cross-section of a coated component having a roughened profile created by means of the method according to the invention.

FIG. 2 (a), (b), (c), cross-sections of different preliminary stages of the roughened profile resulting from the first work step;

FIG. 3 (a), (b), (c), cross-sections of different roughened profiles after the second work step;

FIG. 4 a first exemplary embodiment of a combined machining and shaping tool.

FIG. 5 a second exemplary embodiment of a combined machining and shaping tool;

FIG. 6 a third exemplary embodiment of a combined machining and shaping tool;

FIG. 7 a fourth exemplary embodiment of a combined machining and shaping tool;

The drawings described herein are for illustration purposes only and are not intended to limit the scope of the present disclosure in any way.

### DETAILED DESCRIPTION

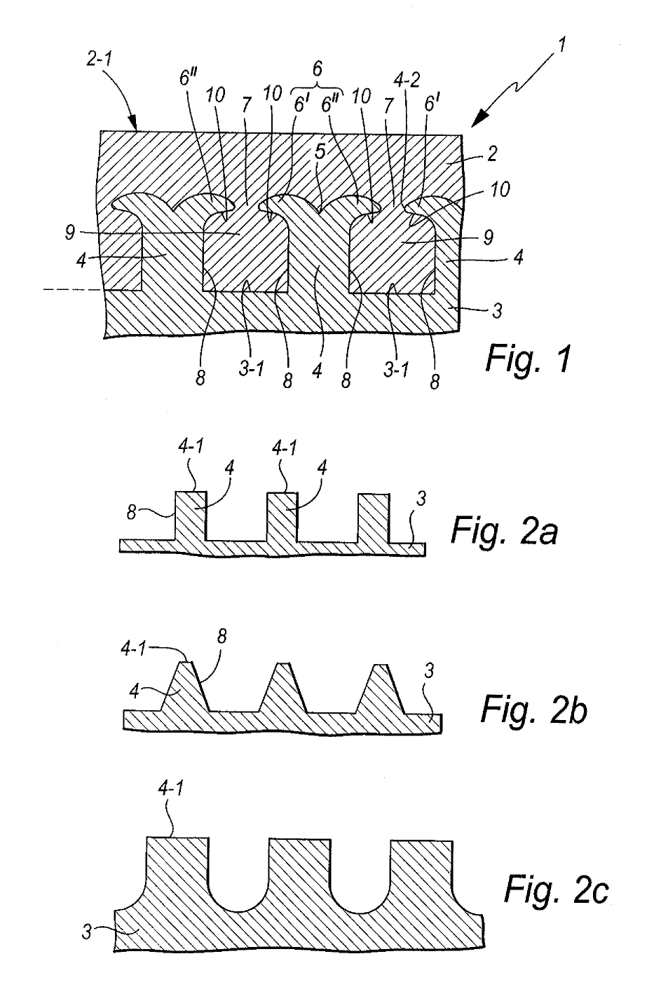

FIG. 1 shows a section of a coated component 1, namely across the surface of a cylinder bore of an internal combustion engine. The component is formed by a substrate 3, for example, made of aluminum, which is provided with a coating 2. The coating 2 is created by spraying a metal powder heated up to the melting point, for example, an Ni—B alloy. This coating has the desired tribological properties (with regard to the coating technology, see, for example, Flores, Hofineister, Schnell, Vorbehandlung und Honen thermischer Spritzschichten (Pretreatment and honing of thermal spray coatings), in: Yearbook Schleifen, Honen, Lappen und Polieren (grinding, honing, buffing and polishing), Vol. 63, 2007, published by Vulkan, p. 290 ff., as well as Spur, Stöferle [editors], Handbuch der Fertigungstechnik (Production Engineering Manual), Vol. 4/1, Abtragen, Beschichten (stripping, coating), published by Carl Hanser [1987], p. 483 ff).

In order to improve the adhesion of the coating 2 to the substrate 3, the surface thereof is provided with a roughened profile. This roughened profile is characterized by a web 4, which extends in a thread-like manner around the periphery of the inner surface of the cylinder bore, a small part of which is shown in cross-section in FIG. 1. This web 4 has a widened region 6 on the end thereof facing the surface 2-1 of the coating 2, starting at the center 5, said region being formed by the roof-shaped or chamfered projections 6′, 6″ protruding on both sides beyond the vertical flanks 8 of the web 4 shown in FIG. 1, the projections tapering in the direction of the ends 4-2 thereof. The widened region 6 is wider than the web 4 and has surfaces in the direction of the bottom 3-1 of the substrate 3, which form undercuts 10. They result in firm bonding of the coating 2 on the substrate 3 and consequently in high adhesive pull strength.

FIG. 2a shows sections of a web 4 having a square cross-section, FIG. 2b of a web 4 having a trapezoidal cross-section, and FIG. 2c of a web 4 having a U-shaped cross-section, each after the first machining or laser beam processing step and prior to the second shaping step. The web 4 has a substantially flat plateau surface 4-1, which is subsequently shaped, starting at the center 5, such that the roughened profiles shown in FIG. 3 (a), (b), (c) are obtained.

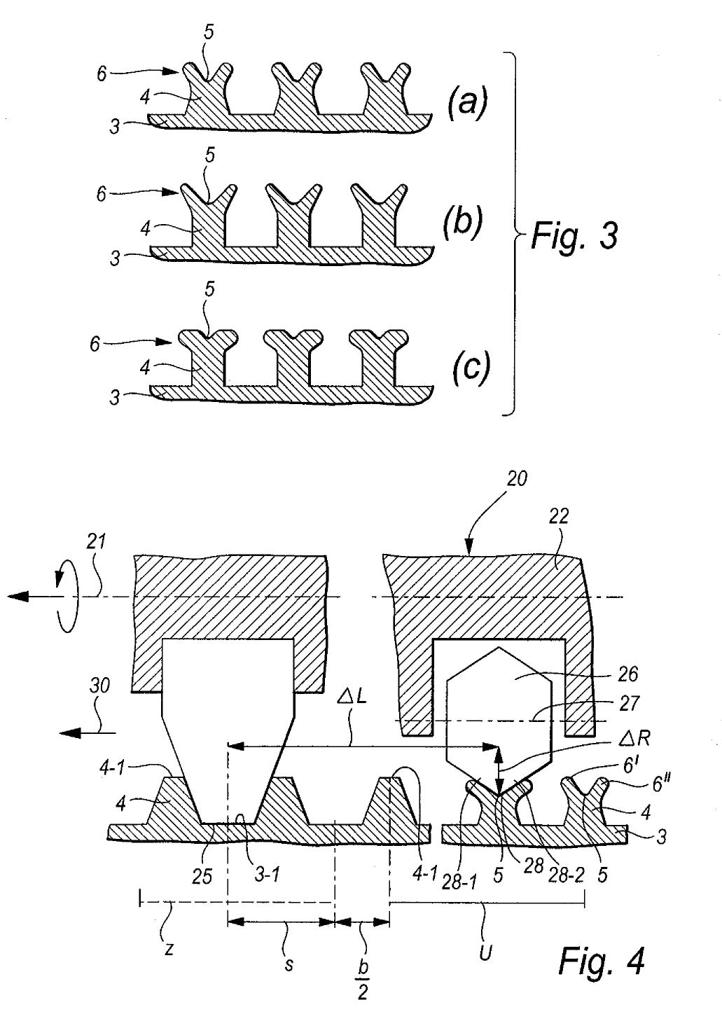

FIG. 4 shows a section of a first exemplary embodiment of a combined machining and shaping tool 20, hereinafter designated as tool for the sake of simplicity, which rotates about the axis of rotation 21 and serves to create a roughened profile on the substrate 3, which in this case is the section of a cylindrical bore of a engine block, having a shape cutter 25, which constitutes the machining element, as well as a roller burnishing tool 26, which constitutes the shaping element. The shape cutter 25 and the roller burnishing tool 26, the latter being rotatable about the axis of rotation 27, are received in a tool body 22.

When the combined machining and shaping tool 20 rotates about the axis of rotation 21 thereof and the shape cutter 25 engages in the surface of the substrate 3 with simultaneous advancement in the direction 30, the web 4 having a trapezoidal cross-section and the flat plateau surface 4-1 is cut in a thread-like manner into the surface of the substrate. Following in the direction 32 of the advancement of the shape cutter 25, the plateau surface 4-1 is then rolled out toward the widened region 6 by the roller burnishing tool 26, starting at an engagement of a raised lug 28 of the roller burnishing tool (26), which starts at the center 5 of the web 4.

The center of the shape cutter 25 is arranged axially offset from the lug 28 by the amount ΔL along a lateral surface line of the rotating tool. In this case ΔL is equal to an integer multiple of the gradient s plus half the profile width b, which is to say (n*s+b/2). Vertical to the advancement direction, which is to say in the radial direction, the lug 28 of the roller burnishing tool 26 is offset by the amount ΔL from the shape cutter 25, which corresponds to the amount by which the widened region 6 is rolled out relative to the previously unwidened plateau surface. This results in the roughened profile illustrated in FIG. 3. It shall be understood that the widened region 6 is rolled out from the plateau surface 4-1 in several steps by means of a plurality of consecutively arranged shaping tools. There is no need for the element of the combined machining and shaping tool 20 used for shaping to be a roller burnishing tool. It may also be a tool for pressing or cutting, with subsequent bending to the sides. In this way, the final roughened profile is obtained by machining in the area Z and shaping in the area U.

The machining tool 25 and shaping tool 26 are configured as two separate units and, as already mentioned, arranged radially and axially offset from one another. While machining a work piece, they are fixed in relation to one another, but may also be adjusted radially as well as axially relative to one another. In this case, machining is a fine boring process, by means of which the webs 4 are created in a thread-like manner along the periphery of the substrate, the thread having a certain pitch.

A machining and shaping tool of the described type may be combined with a tool for position honing according to DE 103 48 419 (=U.S. Pat. No. 7,416,475). This is a method for rough honing the lateral area of a bore, wherein the position of the bore axis is corrected such that it is flush with and/or matches the axis of rotation of the honing tool and consequently of the honing spindle. To this end, the honing tool, which is fixed relative to the axis of rotation thereof, is inserted eccentrically into the bore so that it at first only cuts a part of the cylindrical inner surface of the bore (partial cut). With increasing machining and resultant radial expansion of the honing tool, the part of the periphery of the cylindrical inner surface of the bore being cut becomes enlarged until the bore is completely machined (full width). The position of the bore then matches the position of the axis of rotation of the honing tool. A honing tool of this type may be arranged on the same tool body in the advancement direction in front of the described machining and shaping tool. The above patent specification is hereby expressly incorporated as part of the subject matter of the disclosure of the present application. The process step of position honing, however, may also be carried out with a separate tool.

To this end, the function of position honing is to correct the position of the axis and direction of the bore axis. If a tool for position honing and a combined machining and honing tool are arranged consecutively on a tool body, position honing is carried out as a first step, followed by the machining and shaping steps according to the present invention. Both process steps may be carried out on one or more machining spindles.

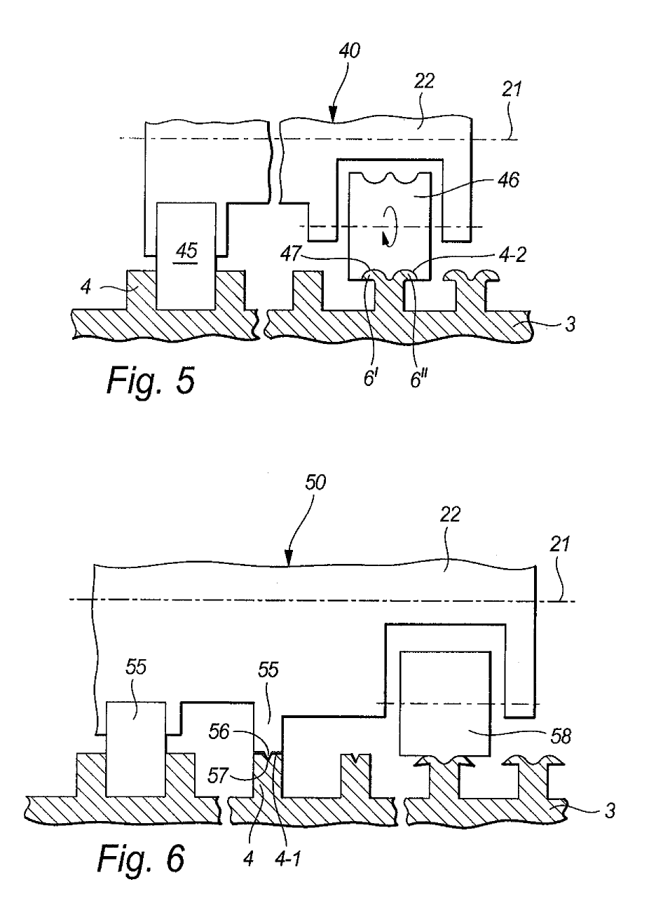

FIG. 5 shows a machining and shaping tool 40. In contrast to the tool according to FIG. 4, this tool has a rectangular shape cutter 45, followed at a radial distance by a roller burnishing tool 46 having a bulge 47. This configuration serves to achieve further flattening of the ends 4-2 of the projections 6′.

It is essential for all exemplary embodiments that the shaping of the plateau surface 4-1 of the web 4 may be consecutively be carried out with shaping tools arranged at a variable radial distance from the axis 27 or on a subsequent spindle.

FIG. 6 shows a machining and shaping tool 50, wherein a first shaping tool 55 is arranged in the axial direction behind the rectangular shape cutter 55 for creating a notch 57 in the center of the plateau surface 4-1 and a second shaping tool 58 is provided adjacent thereto. The first shaping tool 56 may be a roller burnishing tool, a fixed pressure tool, an additional machining tool or a beam tool for cutting with a laser beam or water jet. The second shaping tool 58 is a roller burnishing tool. The corresponding stages of creating the roughened profile are shown at the bottom of FIG. 6. The notch 57 serves the engagement and guiding of the lug 28 and consequently of the roller burnishing tool 26. Shaping jaws 28-1 and 28-2 are arranged on both sides of the lug 28.

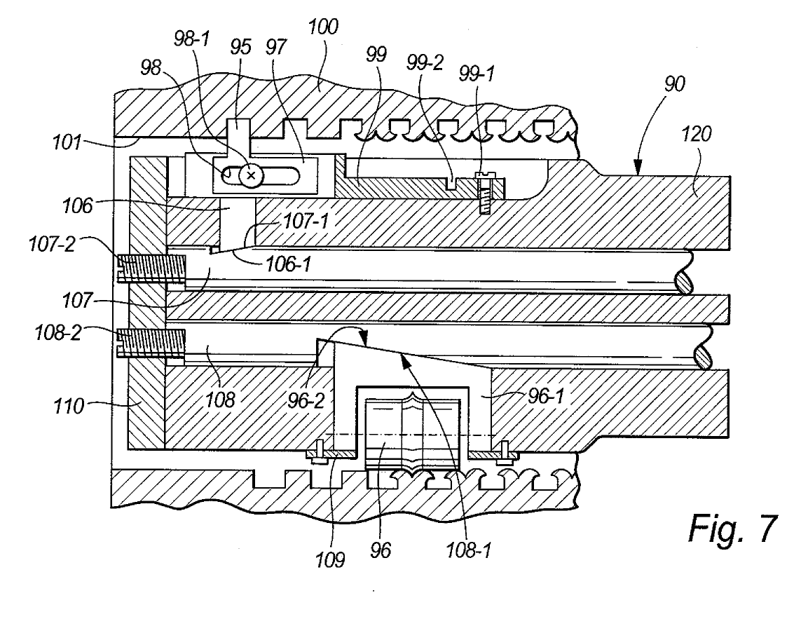

FIG. 7 shows a machining and shaping tool 90 arranged in the bore 101 of a work piece 100, such as the engine block of an internal combustion engine. Machining is carried out by the shape cutter 95, shaping by the roller burnishing tool 96. Both are offset 180°, which is to say on different lateral surface lines of the tool body 120. The shape cutter 95 is arranged on a plate 97, which in turn has an elongated hole 98, via which the plate 97 is screwed to a cutter holder 99 by means of a screw 98-1. This serves for the axial adjustment and alignment of the shape cutter 95 on the cutter holder 99, according to ΔL in FIG. 4. The cutter holder 99 is arranged in a slot 105 in the tool body 120. The section 99-3 thereof to the right of a bending notch 99-2 is screwed to the base of the slot 105 by means of the screw 99-1. An adjusting pin 106 actuates the section 99-4 to the left of and at an adequate distance from the bending notch 99-2, the radial adjustment of the pin in the tool body 120 allowing the cutter holder 99 to the left of the bending notch 99-2 to be easily tilted about the rotating point defined by the bending notch 99-2 and thus aligned radially. The radial adjustment of the adjusting pin 106 takes place in that the lower end thereof having a slightly oblique 106-1 extends on an oblique surface 107-1 of an adjusting rod 107. The adjusting rod 107 is placed in the desired position from the machine, as viewed in FIG. 7 from above. The end position thereof is limited by a stop screw 107-2, which is arranged adjustably as a threaded pin in a cover 110, which is screwed to the tool body 120.

The radial adjustment of the roller burnishing tool 96, corresponding to ΔR in FIG. 4, takes place in that a housing 96-1, in which the roller burnishing tool 96 is rotatably supported, is arranged radially displaceably in a recess 112 in the tool body 120 and provided with a wedge surface 96-2, which may be displaced by a wedge surface 108-1 of an adjusting rod 108. The adjusting rod 108-2 is likewise adjusted from above, which is to say from the machine, against the stop screw 108-2. On restoring of the adjusting rod 108, the housing 96-1 and consequently the entire roller burnishing tool 96 are pressed back to the initial position by leaf springs 109, which are screwed to the tool body 120 and act on the lateral flanks of the housing 96-1.

A common adjusting system arranged centrically may be used for adjusting the shape cutter 95 and the roller burnishing tool 96. Both adjustments acting independently of one another are then designed as slit cones or are designed as a centric adjusting pin having a concentric adjusting sleeve.

It should be noted that the disclosure is not limited to the embodiment described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

1. A method of preparing a surface of a substrate for applying a thermal spray coating, recesses being introduced in the surface to be coated by machining, which are subsequently shaped such that the created structures have undercuts, characterized in that a web having a plateau surface is created by machining, the web then being shaped to form a widened region starting at approximately the center of the plateau surface, said region forming roof-shaped projections toward both sides, which form undercuts facing the substrate.

2. The method according to claim 1, characterized in that the web extends in a thread-like manner along the periphery of the inner surface of a bore.

3. The method according to claim 1, characterized in that the cross-section of the web is rectangular, trapezoidal or U-shaped.

4. The method according to claim 1, characterized in that the surface to be prepared for applying a thermal spray coating is the cylindrical piston running surface of an internal combustion engine, for example the cylinder bore of a crankcase or a cylinder liner.

5. The method according to claim 4, characterized in that by the simultaneous rotation and axial advancement of a combined machining and shaping tool the web is configured such that it runs in a thread-like manner with a certain pitch along the inner surface of the bore.

6. The method according to claim 1, characterized in that a distance of the machining element to the shaping element of the combined machining and shaping tool positioned and adjusted or offset from one another.

7. The method according to any claim 6, characterized in that, as an intermediate step between the machining and shaping operations, a notch is introduced into the plateau surface of the web in approximately the center thereof for inserting and/or guiding the shaping tool.

8. The method according to claim 3, characterized in that, before creating the web, a bore is created on the cylindrical inner surface for correcting the position of the bore axis by position honing and for correcting the bore axis, wherein a honing tool, the axis of rotation of which is fixed in the honing spindle, is introduced eccentrically into the bore in order to first remove stock only along part of the peripheral surface of the bore and continuing the machining process with increasing widening of the diameter of the peripheral surface until the stock removal is carried out along the entire peripheral surface.

9. The method according to claim 8, characterized in that the stock removal is carried out by means of laser shaping when configuring the web.

10. A tool for creating a roughened profile on the inner surface of a bore, characterized in that the tool may be introduced into the bore, rotated therein, displaced in a controlled manner in an advancement device and configured as a combined machining and shaping tool, wherein it has a machining element for creating a web extending in a thread-like manner along the periphery of the bore as a preform of a roughened profile and an element at an adjustable axial and radial distance thereto for shaping this web, said element shaping a plateau surface of the web to form projections to both sides, the projections protruding over flanks of the web and forming undercuts on the side facing a bottom of an intermediate space between convolutions of the web, which serve the bonding of a coating to be applied by spraying, whose tribological properties are better than those of the bore material.

11. The tool according to claim 10, characterized in that the shaping tool is a roller burnishing tool, the engagement profile of which comprises an area configured as a lug and slightly recessed shaping jaws on both sides thereof opposite the lug, via which the plateau surface is shaped into a widened region starting at the center of the flat plateau surface, said region having roof-shaped projections pointing away from the web on both sides, on which undercuts are created.

12. A tool for creating a roughened profile for an inner surface of a bore, preferably for a piston running surface of a crankcase of an internal combustion engine, to be spray coated with a heated metal, characterized in that in a tool body, which may be inserted into the bore rotatably and displaceably in the advancement direction, in a first recess arranged along a periphery a first holding means holding a shape cutter is arranged that may be adjusted radially by a first adjusting means that may be adjusted axially in the tool body, and that in a second recess a second holding means holding a shaping device is arranged, which may be radially adjusted by a second adjusting means that may be adjusted axially in the tool body, and that the position of at least one of the two holding means may be adjusted axially in the direction of an axis of rotation, and that the recess, in which the second holding means is arranged, is arranged offset in an advancement direction behind the first holding means.

13. The tool according to claim 12, characterized in that the first holding means is a cutter holder, which may be displaced axially in a slot running axially along a periphery of the tool body.

14. The tool according to claim 13, characterized in that the shape cutter is axially displaceable on the cutter holder.

15. The tool according to claim 14, characterized in that the adjusting means for the first holding means is an adjusting rod axially displaceable in the tool body, the rod by means of an oblique surface provided thereon acting on an oblique surface of a radially displaceable adjusting pin, which adjusts the cutter holder in the radial direction.

16. The tool according claim 15, characterized in that the cutter holder is fixed in the slot and provided with a bending notch, and that the adjusting pin acts in one point on the cutter holder, which swivels it at a point defined by the bending notch with respect to the section thereof fixed in the slot.

17. The tool according to claim 12, characterized in that the second holding means may be displaced radially in the second recess.

18. The tool according to claim 17, characterized in that the adjusting means for the second holding means is an adjusting rod axially displaceable in the tool body, the rod acting on an oblique surface of the second holding means by means of an oblique surface provided thereon and displacing the holding means in the radial direction.

19. A tool according to claim 12, characterized in that the shaping device is a roller burnishing tool arranged rotatably on the holding means.

20. The tool according to claim 19, characterized in that the roller burnishing tool has a centrally arranged protrusion suitable for engaging in a notch as a guide, the protrusion having shaping jaws on both sides for configuring the projections.

21. A tool according to claim 19, characterized in that at least one spring arranged on the tool body acts on the holding means by pressing the tool body into the initial position thereof.

22. A crankcase of an internal combustion engine provided with a cylinder bore, wherein the inner surface of the bore, or a cylinder liner inserted therein, is provided with a roughened profile, which is configured by a web having at least one of a trapezoidal, rectangular and a U-shaped cross-section and extending in a thread-like manner along the periphery of the inner surface of the bore, a plateau surface of the profile having undercuts protruding on both sides over the flanks of a web, a sprayed metal coating, which has improved tribological properties with respect to the material of the engine block, being held by said undercuts on the inner surface of the bore in addition to the holding forces provided by adhesion.
